(19) United States
(12) Patent Application Publication
(10) Pub. No.: US 2020/0042322 A1
(43) Pub. Date: Feb. 6, 2020

(54) SYSTEM AND METHOD FOR STORE INSTRUCTION FUSION IN A MICROPROCESSOR

(71) Applicant: Futurewei Technologies, Inc., Plano, TX (US)

(72) Inventors: Qian Wang, Santa Clara, CA (US); Xiaohan Ma, Santa Clara, CA (US); Xingyu Jiang, Palo Alto, CA (US)

(73) Assignee: Futurewei Technologies, Inc., Plano, TX (US)

(21) Appl. No.: 16/054,413

(22) Filed: Aug. 3, 2018

(51) Int. Cl. G06F 9/38; G06F 9/30

(52) U.S. Cl. CPC G06F 9/3851; G06F 9/3001; G06F 9/30181

(57) ABSTRACT

The disclosure relates to technology executing store and load instructions in a processor. Instructions are fetched, decoded and renamed. When a store instruction is fetched, the instruction is cracked into two operation codes in which a first operation code is a store address and a second operation code is a store data. When a fusion condition is detected, the second operation code is fused or merged with an arithmetic operation instruction for which a source register of a store instruction matches a destination register of the arithmetic operation instruction. The first operation code is then dispatched/issued to a first issue queue and the second operation code, fused with the arithmetic operation instruction, is dispatched/issued to a second issue queue.

### FIELD

The disclosure generally relates to processing of pipelined computer instructions in a microprocessor.

### BACKGROUND

Instruction pipelining in computer architectures has improved utilization of CPU resources and faster execution times of computer applications. Instruction pipelining is a technique used in the design of the microprocessors, microcontrollers and CPUs to increase instruction throughput (i.e., the number of instructions that can be executed in a unit of time).

The main idea is to divide (or split) the processing of a CPU instruction, as defined by the instruction microcode, into a series of independent steps of micro-operations (also called “microinstructions”, “micro-op” or “p-op”), with storage at the end of each step. This allows the CPUs control logic to handle instructions at the processing rate of the fastest step, which is much faster than the time needed to process the instruction as a single step. As a result, in each CPU clock cycle, steps for multiple instructions may be evaluated in parallel. A CPU may employ multiple processor pipelines to further boost performance and fuse instructions (e.g. p-ops) into one macro operation.

### BRIEF SUMMARY

According to one aspect of the present disclosure, there is a computer-implemented method for executing instructions in a processor, comprising detecting, at an instruction fusion stage, a fusion condition exists in response to a source register of a store instruction matching a destination register of an arithmetic operation instruction; cracking the store instruction into two operation codes, wherein a first operation code includes a store address and a second operation code includes a store data; and dispatching the first operation code to a first issue queue and the second operation code, fused with the arithmetic operation instruction, to a second issue queue.

Optionally, in any of the preceding aspects, the computer-implemented method further comprises fetching one or more instructions from memory based on a current address stored in an instruction point register, wherein the one or more instructions comprise at least one of the store instruction and the arithmetic operation instruction.

Optionally, in any of the preceding aspects, the computer-implemented method further comprises decoding the fetched one or more instructions by a decoder into at least one execution operation; issuing the first operation code stored in the first issue queue for execution in a load/store stage; and issuing the second operation code fused with the arithmetic operation instruction, stored in the second issue queue, for execution in an arithmetic logic unit (ALU).

Optionally, in any of the preceding aspects, the computer-implemented method further comprises executing the first operation code and the second operation code, fused with the arithmetic operation instruction, upon issuance by a respective one of the first and second issue queues.

Optionally, in any of the preceding aspects, execution of the first operation code is performed in a load/store stage and execution of the second operation code fused with the arithmetic operation instruction is performed in an arithmetic logic unit (ALU).

Optionally, in any of the preceding aspects, the second operation code fused with the arithmetic operation instruction are stored in a single physical entry of the second issue queue.

Optionally, in any of the preceding aspects, the computer-implemented method further comprises completing the store instruction when all instructions older than the store instruction have completed and when all instructions in an instruction group that included the store instruction have completed.

Optionally, in any of the preceding aspects, the first and second operation codes are micro-operation instructions.

Optionally, in any of the preceding aspects, the arithmetic operation instruction is one of an ADD, SUBTRACT, MULTIPLY, DIVIDE or a logical operator.

According to one other aspect of the present disclosure, there is a processor for executing instructions, comprising fusion logic detecting a fusion condition exists in response to a source register of a store instruction matching a destination register of an arithmetic operation instruction; cracking logic cracking the store instruction into two operation codes, wherein a first operation code includes a store address and a second operation code includes a store data; and a dispatcher dispatching the first operation code to a first issue queue and the second operation code, fused with the arithmetic operation instruction, to a second issue queue.

According to one other aspect of the present disclosure, there is a non-transitory computer-readable medium storing computer instructions, that when executed by one or more processors, cause the one or more processors to perform the steps of detecting a fusion condition exists in response to a source register of a store instruction matching a destination register of an arithmetic operation instruction; cracking the store instruction into two operation codes, wherein a first operation code includes a store address and a second operation code includes a store data; and dispatching the first operation code to a first issue queue and the second operation code, fused with the arithmetic operation instruction, to a second issue queue.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures for which like references indicate elements.

FIG. 1 illustrates an example pipeline of a processor in accordance with one embodiment.

FIG. 2 illustrates a block diagram of a temporary storage in a reorder buffer (ROB).

FIG. 3 illustrates an example pipeline of a processor in accordance with one embodiment.

FIGS. 4A and 4B illustrate flow diagrams of an instruction fetch and execution process implementation.

FIG. 5A illustrates an example process flow of instructions in a processing pipeline.

FIG. 5B illustrates an example of instructions stored in a scheduler.

FIGS. 5C-5E illustrate cycles in the process flow of FIGS. 4A and 4B.

FIG. 6 is a block diagram of a network device 800 that can be used to implement various embodiments.

### DETAILED DESCRIPTION

The present disclosure will now be described with reference to the figures (FIGS.), which in general relates to execution of instruction in a microprocessor.

Processors generally include support for load memory operations and store memory operations to facilitate transfer of data between the processors and memory to which the processors may be coupled. A load memory operation (or load operation or load) is an operation specifying a transfer of data from a main memory to the processor (although the transfer may be completed in cache). A store memory operation (or store operation or store) is an operation specifying a transfer of data from the processor to memory. Load and store operations may be an implicit part of an instruction which includes a memory operation, or may be explicit instructions, in various implementations.

A given load/store specifies the transfer of one or more bytes beginning at a memory address calculated during execution of the load/store. This memory address is referred to as the data address of the load/store. The load/store itself (or the instruction from which the load/store is derived) is located by an instruction address used to fetch the instruction, also referred to as the program counter address. The data address is typically calculated by adding one or more address operands specified by the load/store to generate an effective address or virtual address.

To increase the operating speed of microprocessors, some architectures have been designed and implemented that allow for the out-of-order execution of instructions within the microprocessor. For example, store instructions may be cracked into two portions—store data and store address, each of which may then be separately executed. The store address portion may be executed in a load store, while the store data portion may be executed in another execution resource. Prior to execution, however, each execution resource has a corresponding scheduler that holds the instructions before the source registers are ready. Once a source register ready, the corresponding instruction may go to the execution resource for execution. The store instruction completes when both portions have been executed.

The cracked store instructions occupy an extra scheduler entry, which reduces the efficiency of the scheduler entry usage, while the number of entries of the scheduler directly limits the out of order instruction window. To resolve this inefficiency, the disclosed technology fuses two or more separate instructions (e.g., a store data and arithmetic operation) into a single fused instruction which may then be stored and processed by the microprocessor. By fusing the two instructions in this manner, and storing the fused instruction as a single (shared) entry in memory (e.g. in the scheduler), wakeup latency is saved by at least one cycle. In one embodiment, the fusion condition detection occurs in a mapping (rename) stage of pipeline, without incurring extra detection/comparison logic.

It is understood that the present embodiments of the disclosure may be implemented in many different forms and that claims' scopes should not be construed as being limited to the embodiments set forth herein. Rather, these embodiments are provided so that this disclosure will be thorough and complete and will fully convey the inventive embodiment concepts to those skilled in the art. Indeed, the disclosure is intended to cover alternatives, modifications and equivalents of these embodiments, which are included within the scope and spirit of the disclosure as defined by the appended claims. Furthermore, in the following detailed description of the present embodiments of the disclosure, numerous specific details are set forth in order to provide a thorough understanding. However, it will be clear to those of ordinary skill in the art that the present embodiments of the disclosure may be practiced without such specific details.

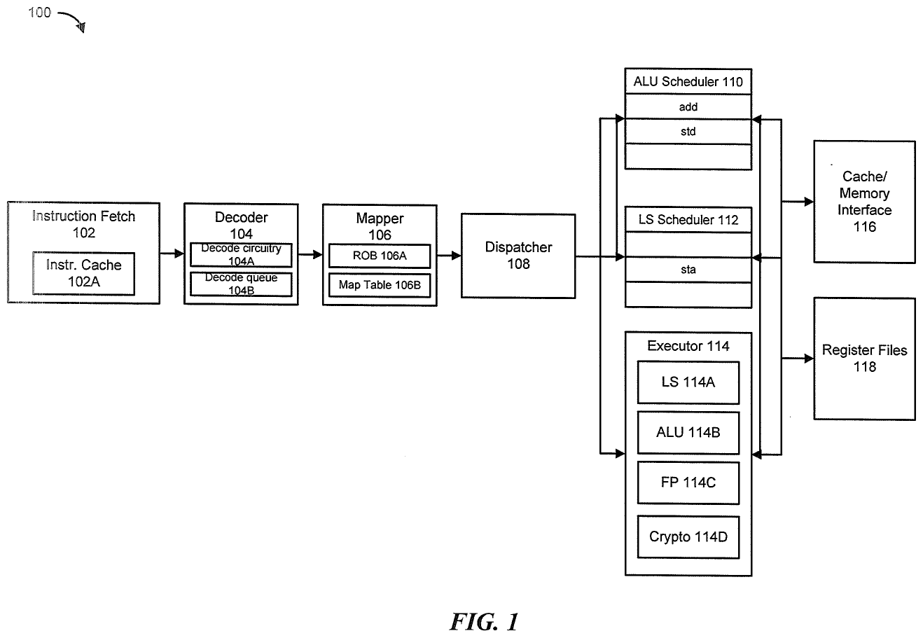

FIG. 1 illustrates an example pipeline of a processor in accordance with one embodiment. In particular, the pipeline shows a store instruction that flows down the pipeline with an add instruction, in which a fused instruction may be generated. As illustrated, processor 100 includes an instruction fetch 102, decoder 104, mapper 106, dispatcher 108, arithmetic logic unit (ALU) scheduler 110, load/store (LS) scheduler 112, executor 114, cache/memory interface 116 and register files 118.

Instruction fetch 102, which includes instruction cache 102A, is coupled to an exemplary instruction processing pipeline that begins with decoder 104 and proceeds through mapper 106, dispatcher 108. The dispatcher and issuer 108 is coupled to issue instructions to executor 114, which may include any number of instruction execution resources, such as LS 114A, ALU 114B, floating-point (FP) 114C and crypto 114D. The executor 114 is coupled to register files 118. Additionally, ALU scheduler 110 and LS scheduler 112 are coupled to cache/memory interface 116.

Instruction fetch 102 may provide instructions (or a stream of instructions) to the pipeline for execution. Execution may be broadly defined as, but is not limited to, processing an instruction throughout an execution pipeline (e.g., through fetch, decode, execute, etc.), processing an instruction at an instruction execution resource of the executor (e.g., LS, ALU, etc.), retrieving a value of the load's target (i.e., the location from/to which a load instruction is read/written) location, or the entirety of operations that occur throughout the pipeline as a result of the load instruction. In one embodiment, the instruction fetch 102 may also include look-ahead operations for condition branches in which branch prediction logic (not shown) predicts an outcome of a decision that effects program execution flow, which at least contributes to allowing the processor 100 to execute instructions speculatively and out-of-order.

In one embodiment, instruction fetch 102 may fetch instructions from instruction cache 102A and buffer them for downstream processing, request data from a cache or memory through cache/memory interface 116 in response to instruction cache misses. Although not illustrated, instruction fetch 102A may include a number of data structures in addition to the instruction cache 102A, such as instruction buffers and/or structures configured to store a state that is relevant to thread selection and processing. Decoder 104 may prepare fetched instructions for further processing. Decoder 104 may include decode circuitry 104A for decoding the received instructions and a decode queue 104B for queuing the instructions to be decoded. The decoder 104 may also identify the particular nature of an instruction (e.g., as specified by its opcode) and to determine the source and destination registers encoded in an instruction, if any. In one embodiment, the decoder 104 is configured to detect instruction dependencies and/or to convert complex instructions into two or more simpler instructions for execution. For example, the decoder 104 may decode an instruction into one or more micro-operations (p-ops), which may also be referred to as “instructions” when they specify an operation to be performed by a processor pipeline.

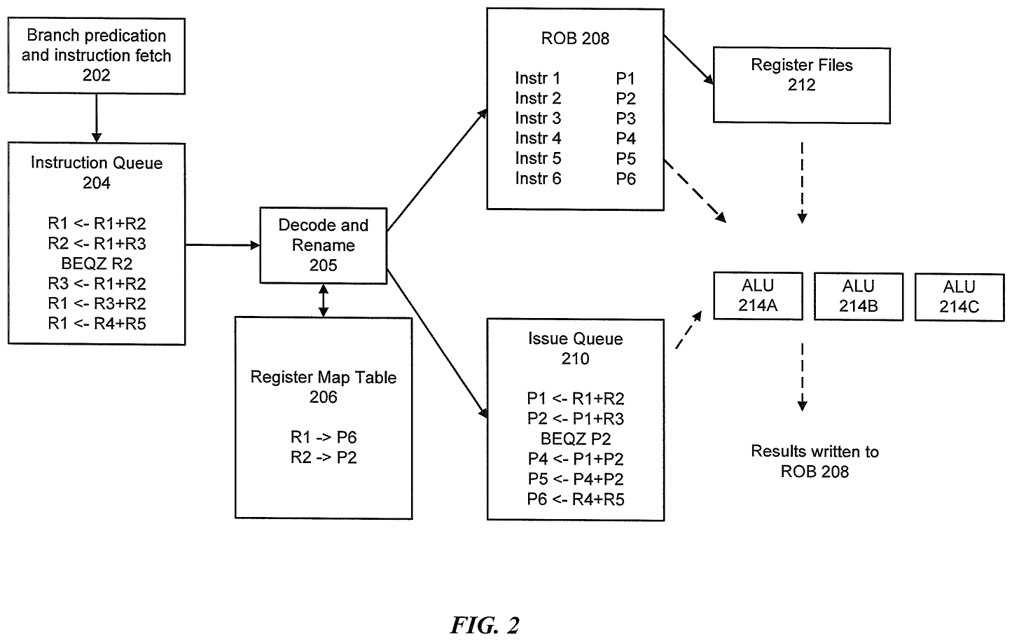

Mapper 106 renames the architectural destination registers specified by instructions by mapping them to a physical register space. In general, register renaming may eliminate certain dependencies between instructions (e.g., write-after-read or “false” dependencies), which may prevent unnecessary serialization of instruction execution. In one embodiment, mapper 106 may include a reorder buffer (ROB) 106A that stores instructions being decoded and renamed. A map table (or map) 106B that may be maintained in the mapper 106 details the relationships between architectural registers and physical registers, such that the name mapping is tracked for each register. An example of an out-of-order processor implementation, including renaming using ROB 106A, is detailed in FIG. 2 below. In one embodiment, the ROB 106A and/or the map table 106B are located independent of the mapper 106.

Mapper 106 is also responsible cracking (dividing) the received instruction into two internal p-ops, using cracking logic, when the instruction is a store (or load) instruction. First, a determination is made as to whether the received instruction is a store instruction. If not, then the instruction may proceed down the pipeline for processing and execution. However, if the received instruction is determined to be a store instruction, then the instruction is cracked into two internal p-ops. The first p-op is a store address that is sent to the LS scheduler 112, the second p-op is a store data that is sent to ALU scheduler 110. It is appreciated that although an ALU scheduler is depicted in the disclosed embodiment, the processing pipeline is not limited to such an embodiment. Other or additional schedulers, such as a floating point scheduler or crypto scheduler, may also be employed in the processing pipeline. It is also appreciated that although the cracking logic is shown as being in the mapper, the cracking logic may also be included in other stages, independent or otherwise, of the pipeline.

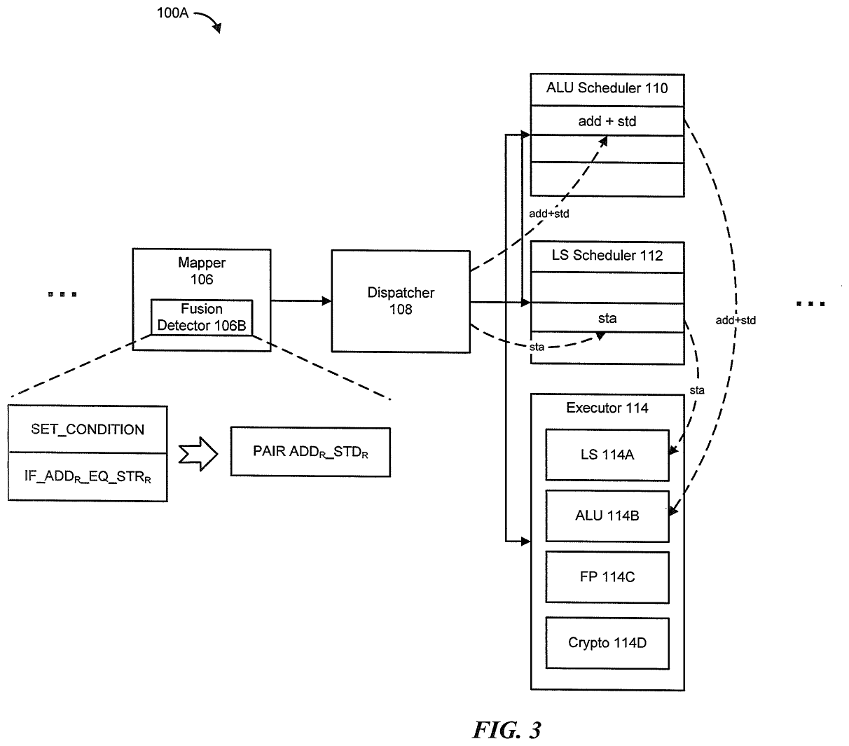

In one embodiment, mapper 106 is also responsible for detecting a fusion condition, and fusing instructions when the fusion condition is detected. It is appreciated that although the fusion condition detection is discussed as being in the mapper, the fusion condition detection may also be included in other stages, independent or otherwise, of the pipeline. Detection of a fusion condition, and fusing instructions, will be described below with reference to FIG. 3.

Once decoded and renamed, instructions may be ready to be scheduled for dispatch and later performance. As illustrated, dispatcher and issuer 108 is configured to schedule (i.e., dispatch and issue) instructions that are ready for dispatch and subsequent performance. Instructions are queued in the dispatcher 108 and sent to the schedulers, such as ALU scheduler 110 and LS scheduler 112, while awaiting operands to become available, for example, from earlier instructions. The scheduler 110 and/or 112 may receive instructions in program order, but instructions may be issued and further executed out of program order (out-of-order). In one embodiment, the dispatcher 108 dispatches the instructions to a schedule queue, such as ALU scheduler 110 and LS scheduler 112, that stores decoded and renamed instructions. The scheduler may be part of or separate from the dispatcher 108. In one embodiment, the schedulers 110 and 112 represent any number of different schedulers, including reservations stations, central instruction window, etc. The schedulers 110 and 112 are also coupled to the physical register files 118.

Instructions issued from ALU scheduler 110 and LS scheduler 112 may proceed to any one or more of the executors (e.g., LS 114A, ALU 114B, etc.) to be performed (executed). In one embodiment, architectural and non-architectural register files are physically implemented within or near executor 114. It is appreciated that in some embodiments, processor 100 may include any number of executors, and the executors may or may not have similar or identical functionality.

LS 114A may carry out load and store operations to a data cache or memory. Although not depicted, LS 114A may include a data cache, load queue and store queue (not shown). In one embodiment, the load queue and store queue are respectively configured to queue load and store instructions until their results can be committed to the architectural state of the processor. Instructions in the queues may be speculatively performed, non-speculatively performed, or waiting to be performed. Each queue may include a plurality of entries, which may store loads/stores in program order.

ALU 114B may perform arithmetic operation such as add, subtract, multiply, divide or other logical operations (e.g., AND, OR or shift operations). In one embodiment, the ALU 114B may be an integer ALU which performs integer operations on 64 bit data operands. In alternative embodiments, the ALU 114B, can be implemented to support a variety of data bits including 16, 32, 128, 256, etc.

Floating point 114C may perform and provide results for floating-point and graphics-oriented instructions. For example, in one embodiment floating point 114C implements single- and double-precision floating-point arithmetic instructions compliant with the IEEE floating-point standards, such as add, subtract, multiply, divide, and certain transcendental functions.

In the above discussion, exemplary embodiments of each of the structures of the illustrated embodiment of processor 100 are described. However, it is noted that the illustrated embodiment is merely one example of how processor 100 may be implemented. Alternative configurations and variations are possible and contemplated.

FIG. 2 illustrates a block diagram of a temporary storage in a reorder buffer (ROB). As illustrated, instructions are fetched at block 202 and placed in an instruction fetch queue 204. In one example, the instructions are the original assembly instructions included in the program executable that refer to the registers (e.g. 32, 64, etc.) defined in the architecture. These registers are the aforementioned architectural registers, which are stored in the architectural register file 212 (showing registers R1-R32).

The instructions fetched at block 202 may be executed in an out-of-order fashion. In order to prevent modification of the contents in the architectural register file 212, each instruction entering the pipeline, for example the pipeline architecture in FIG. 1, is provided with a temporary register where results are stored. The temporary result are ultimately written into the architectural register file 118 in program order. The ROB 208 provides the ability to perform out-of-order processing by tracking the program order in which instructions enter the pipeline. For each of these instructions received into the pipeline, the ROB 208 maintains a temporary register storage.

In the example of FIG. 2, the ROB 208 stores six entries, with the temporary register storage names P1-P6. The example does not contemplate load/store instructions, which will be discussed further below with reference to Table I. Instructions fetched at block 202 and placed into the instruction fetch queue 204 are decoded and renamed at block 205 and placed into the ROB 208. For example, a first instruction (R1<-R1+R2) is renamed to P1<-R1+R2. The table in the ROB 208 maintains and tracks the mapping of each register, where R1 was renamed P1. As the next instruction (R2<-R1+R3) is received, the R1 being references is now P1 and the result is written into P2 (P2<-P1+R3), where R2 was renamed to P2. These renamed instructions are stored in the ROB 208 and the issue queue 210. Register map table 206 identifies how to map the registers during renaming.

After the instructions are renamed and placed in the issue queue 210, the issue queue 210 determines which instructions are ready to be executed in the next cycle. For each instruction, the issue queue 210 tracks whether the input operands for the instruction are available, in which case the instructions may be executed in an execution resource such as ALU 214A, 214B or 214C. For example, if six instructions are simultaneously renamed and placed in the issue queue 210 in a first cycle, the issue queue 210 is aware that registers R1, R2, R4 and R5 are available in the architectural register file 212. Thus, the first and sixth instructions have their operands ready and may begin execution. Each of the other instructions depend on at least one of the temporary register values that have not yet been produced. When the first and sixth instructions have completed execution, the results are written into P1 and P6 and broadcast to the issue queue 210. Writing results into P1 (which is now available in the issue queue) prompts the second instruction to execute in the next cycle, as the issue queue 210 already knew register R3 was ready. When completed, the availability of P2 is broadcast to the issue queue and this prompts the third and fourth instruction to begin execution. Thus, as information becomes available in the issue queue 210, instructions are executed (for example in ALUs 214A-214C) and completed (out-of-order).

As the oldest instruction in the ROB 208 produces a valid result, the instruction may be made permanent (or committed), which writes the result into the architectural register file 212. For example P1 is a temporary storage for register R1, so the value P1 is copied into R1. The ROB 208 also sends a message to the issue queue 210 to advise of the name change. As appreciated, the temporary storage P1-P6 is also known as the rename registers, and the instructions in the pipeline are referred to as speculative instructions since they are not yet committed.

FIG. 3 illustrates an example pipeline of a processor in accordance with one embodiment. In the depicted embodiment, section 100A of processor 100 includes a mapper 106 (including fusion detector 106B), a dispatcher and issuer 108, ALU scheduler 110, LS scheduler 112 and executor 114. While only section 100A of the processor 100 and pipeline is illustrated, it is appreciated that each of the components discussed with reference to the processor 100 shown in FIG. 1 are also part of the full processor pipeline in this embodiment.

As described in the example architecture of FIG. 1, in order to increase the operating speed of microprocessors, execution of instructions “out-of-order” are permitted within the microprocessor. When a load or store instruction is received, the instruction is cracked into two portions—a store data (std) and a store address (sta) for separate execution within a corresponding execution resource, such as LS 114A, ALU 114B, etc. For purposes of discussion, the examples that follow will discuss a store instruction, although the discussion equally applies to a load instruction

Once cracked, the store address portion is executed in LS 114A, while the store data portion is executed in a separate execution resource, such as ALU 114B. Prior to execution, the each store instruction (e.g., store address and store data) is stored in a corresponding scheduler (e.g., LS scheduler 112 and ALU scheduler 110). The two store instructions are held in their respective scheduler until they are ready for execution. For example, the instructions are held in their respective schedulers until such time an operand, for example from an earlier instruction, becomes available. At this time, the instruction may be sent to the proper execution resource (in this case, either LS 114A or ALU 114B). The store instruction completes when both portions of the cracked instruction have been executed.

In the embodiment illustrated in FIG. 1, and as discussed above, the cracked store instructions occupies an extra scheduler entry—one LS scheduler 112 entry and one ALU scheduler 110 entry. The occupancy of the entry in two schedulers reduces the efficiency of scheduler entry usage, while the number of entries of the scheduler directly limits the out of order instruction window.

In the embodiment illustrated in FIG. 3, the cracked store data portion is fused with the operand (earlier instruction) when a fusion condition is detected (i.e., if the earlier instruction produces the data for the store). For example, mapper 106 may include a fusion detector (or fusion condition detector) 106B that is responsible for detecting a fusion condition and fusing instructions when the fusion condition is detected. As shown in the exploded view of the fusion detector 1066, the fusion detector 1066 may set and store one or more conditions that are indicative of a fusion condition. In the depicted example, a condition is set such that if the destination register of the operand instruction (earlier instruction) matches the source register of the store data instruction, then the two instructions are fused. As a result, no extra entry is used for the store instruction, which results in a more efficient use of the scheduler resources and increases processing performance.

In this case, and for purposes of discussion, the earlier instruction is an ALU instruction. Thus, if the ALU instruction (add) produces data for the data store (std), then the data store and the ALU instruction are fused. Once fused, the store data and ALU instruction may then be stored as a single entry (add+std) in the scheduler, as shown in the ALU scheduler 110. This is distinct from the ALU instruction (add) which is stored in a separate entry of the ALU scheduler 110 from the store data (std) in the embodiment of FIG. 1, which require two ALU scheduler entries. The store address (sta) portion, similar to the embodiment of FIG. 1, is stored in the LS scheduler 112.

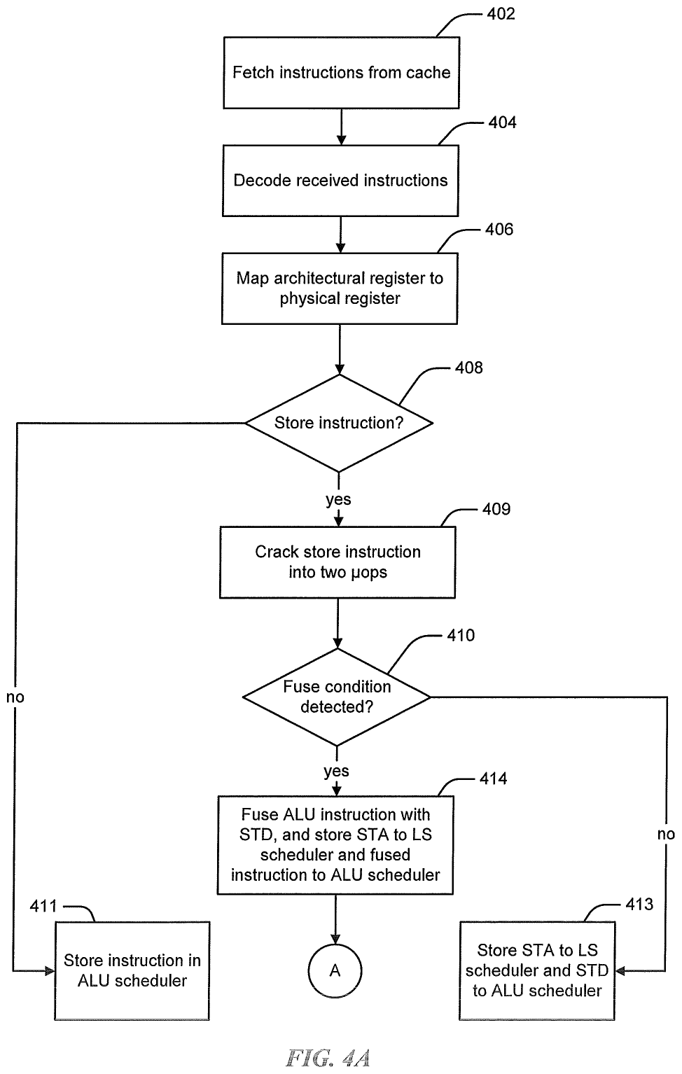

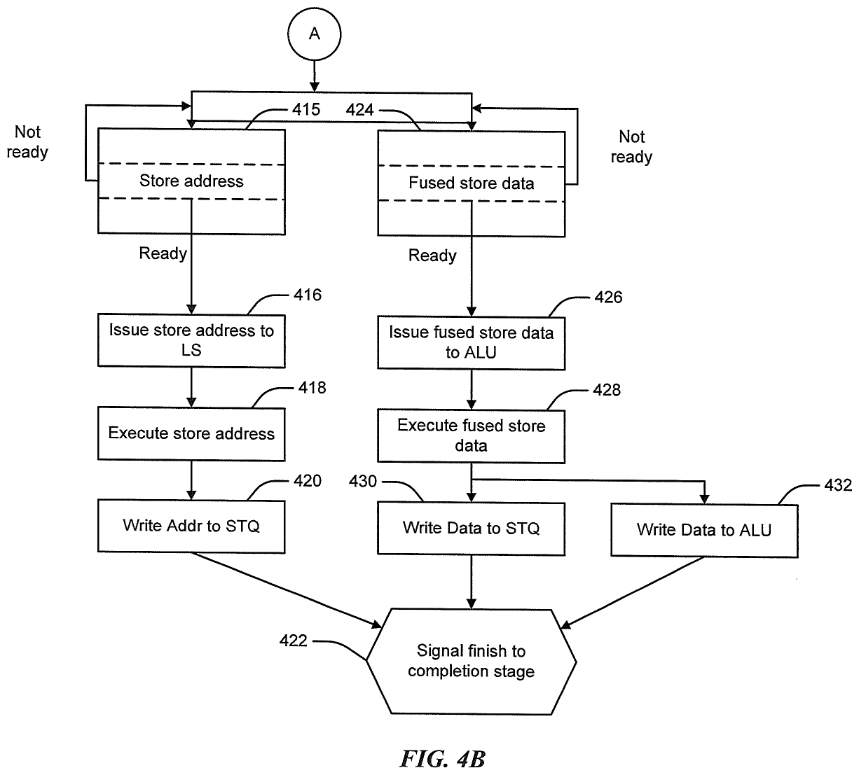

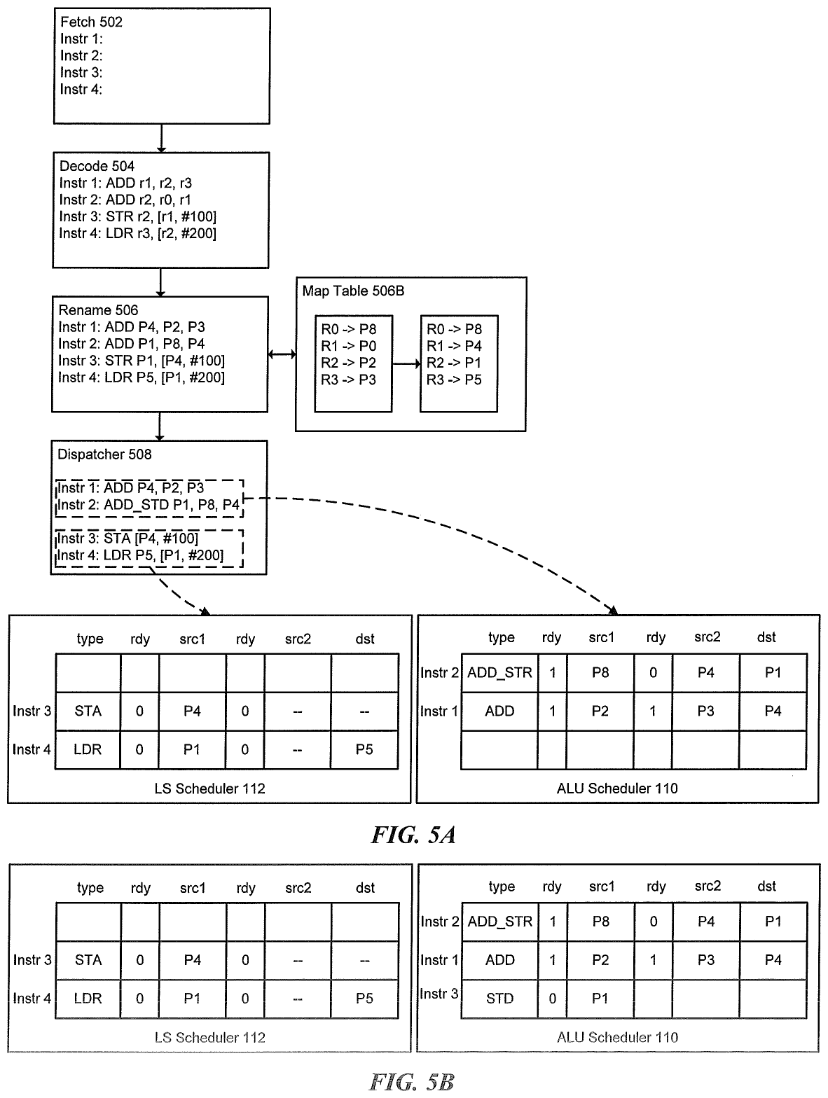

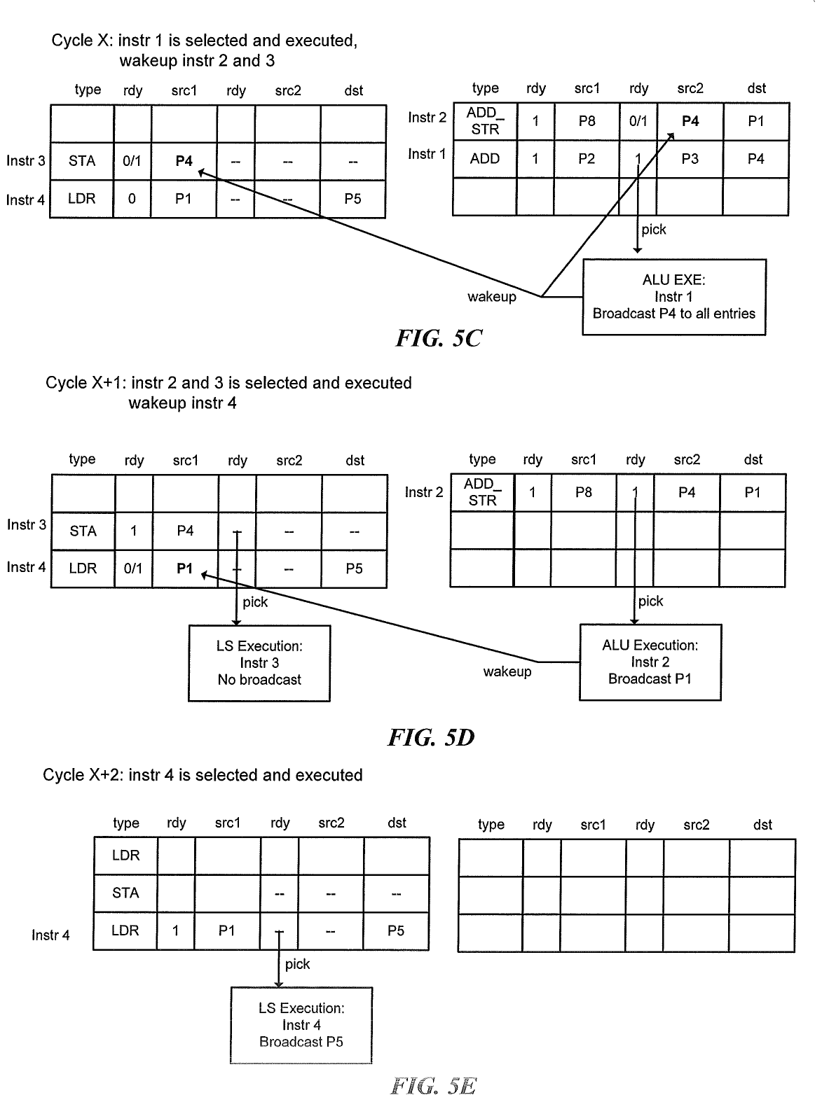

More specifically, and as described in more detail below with reference to FIGS. 4A-5D, the ALU instruction is identified by the architectural register. Since the ALU instruction produces data for the store data, it will rename its destination register to a new physical register, which will be used by the store instruction as its source register. The store data will then be fused with the ALU instructions during mapping (rename) stage.

Once in the scheduler, instructions wait for operands to be ready and are then scheduled for performance. The dispatcher 108 is configured to dispatch instructions that are ready for performance and send the instructions to a respective scheduler. For example, the fused instruction (add+std) is sent to the ALU scheduler 110 and the store address (sta) is sent to the LS scheduler 112, as shown by the dashed arrow lines. The store address and fused instruction can be issued independently once respective source registers are ready. In the case of the fused instruction, the readiness of the source register is dependent upon the ALU instruction source register, as explained above. Thus, after the ALU instruction is issued and executed, the data will be forwarded to the store data for execution, eliminating the need for an extra wakeup for the store data.

In one embodiment, scheduler (e.g., ALU scheduler 110 or scheduler 112) is configured to maintain a schedule queue that stores a number of decoded and renamed instructions as well as information about the relative age and status of the stored instructions. For example, taking instruction dependency and age information into account, the scheduler may be configured to pick one or more instructions that are ready for performance. In one other embodiment, the scheduler may be configured to provide instruction sources and data to the various execution resources in executor 114 for selected (i.e. scheduled) instructions. Instructions issued from a scheduler may proceed to one or more of the execution resources in the executor 114 to be performed. For example, the fused instruction (add+std) may be sent to ALU 114B and the store address (sta) instruction may be sent to the LS 114A for execution, as shown by the dashed lines from the schedulers to the executor 114.

FIGS. 4A and 4B illustrate a flow diagram of instruction pipelining in accordance with FIG. 3. The process disclosed in the figures may be implemented within the pipeline architecture of FIG. 3, which may reside, for example, on a server. For purposes of discussion, reference will be made to FIGS. 5A-5D, which illustrate the processor implementation of instructions and storage during various stages of the pipeline.

Step 402 of FIG. 4A involves the microprocessor 100A fetching program instructions at block 502 from an instruction cache (or memory) 102A. Referring to the example of FIG. 5A, instructions (instr) 1-4 are fetched from the instruction cache 102A at the instruction fetch 102. At step 404, the fetched instructions 1-4 are received at the decoder 104 and decoded by the decoder circuitry 104A. An example instruction decode is shown in block 504 of FIG. 5A, in which each of instructions 1-4 has been decoded to show respective instructions. For example, instructions 1 and 2 respectively show a write (ADD) instruction to architectural register r1 and r2, whereas instructions 3 and 4 respectively show a store (STR) and load (LDR) to the architecture register.

Once the instructions have been decoded, they are sent to the mapper (or rename) 106 stage of the pipeline for renaming at step 406. The mapper 106 is responsible for mapping and renaming the architectural (or logical) register of the instruction to the physical register using the map table. The map table in block 506A is responsible for keeping track of where the architectural registers of the program may be found. For example, architectural source register r3 may be currently found in physical register p3, architectural source register r2 may be found in physical register p2, and so forth. Architectural destination register r1 may be found in physical register p4 after execution of the writing instruction (ADD). A similar process also maps and renames the registers for instruction 2. In one embodiment, as instructions are renamed, a speculative map table may track the most current mapping of the architectural register, which map table may be updated to indicate the more current mapping.

In one embodiment, the mapper 106 determines whether a store instruction (STR) was received in the fetched instructions at step 408. If no store instruction is detected, then the process proceeds to step 411, where the instruction is dispatched and issued for storage in the ALU scheduler (or scheduler corresponding to the type instruction). When the stored instructions are ready, they are issued to an execution resource in executor 114 and executed for completion. If the mapper 106 determines that a store instruction has been received, the process continues to step 409 where the store instruction is cracked into to two p-ops. As depicted in FIG. 5A, instruction 3 includes a store instruction (STR). As a result, decode circuitry 106A in the mapper 106 identifies instruction 3 as a store instruction, and cracks the instruction into two μ-ops—store address (STA) and store dada (STD).

At step 410, the fuse detector 106B of mapper 106 determines whether a fuse condition has been detected. As explained above, a fuse condition is said to exist when the destination register of the operand instruction (earlier instruction) matches the source register of the store data instruction. If the fuse detector 106B determines that a fuse condition does not exist, then process proceeds to step 413, where the cracked store address and store data are dispatched and issued at block for storage respectively in the LS scheduler 112 and the ALU scheduler 110. When the stored instructions are ready, they are issued to an execution resource in executor 114 and executed for completion.

Following the example of FIG. 5A, the fuse detector 106B detects a fuse condition exists at step 410, since instruction 3 is a store instruction having a source register that matches each of the older ALU instructions in the group (i.e., instruction 1 and instruction 2). For example, renamed instruction 3 has a source register P1 that matches the destination register, also P1, of instruction 2 (which is an earlier instruction). Since the register of the source matches the register of the destination, a fuse condition is detected and the store data and ALU instruction may be fused into a single, fused instruction at step 414. Instruction 2 (ADD_STD P1, P8, P4) in dispatch and issue block 508 is one example of a fused instruction. At step 414, the stored address and fused instruction are dispatched and issued by dispatcher 508 to a respective one of the LS scheduler 112 and the ALU scheduler 110 (shown in steps 415 and 424 of FIG. 4B).

With continued reference to FIG. 5A, LS scheduler 112 and ALU scheduler 110 show the instructions dispatched at block 508 and now issued to respective schedulers. As illustrated, instruction 1 and instruction 2 are issued to the ALU scheduler 110 since they both include an operational instruction, such as ADD. In the example, instruction 1 (ADD) shows sources src1 (P2) and src2 (P3) in a ready state (indicated by the “1”) with a destination (dst) of P4. Instruction 2 (ADD_STD), which is the fused instruction from the prior step, shows source src1 (P8) in a read state, src2 (P4) in a non-ready state (indicated by the “0”) and destination (dst) as P1.

Instructions 3 and 4, which include store and load instructions, are issued to the LS scheduler 112 since they are read-only instructions. As shown in the dispatch and issue block 508, instruction 3 shows the store address (STA) portion of the store instruction since it was cracked in the previous steps, whereas instruction 4 shows a load instruction (LDR). The LS scheduler 112 stores the load instruction with a source src1 (P1) in a non-ready state with a destination of P5, and store address instruction with a source src1 (P4) in a non-ready state.

Turning to FIG. 5B, scheduling assignments are shown for comparison between the fusion condition detection technique and the more conventional technique in which instructions are not fused together. In the embodiment of FIG. 5B, the store data (STD) and ALU instruction (ADD) are not fused together during the instruction pipelining. Accordingly, the ALU scheduler needs an additional entry in order to store the store data portion of the cracked store instruction, requiring an extra wakeup cycle for the store data. In the embodiment of FIG. 5A, the fused instruction (ADD_STD) uses a single entry in the ALU scheduler 110, and therefore saves an additional wakeup cycle.

The process implementation by microprocessor 100A continues in FIG. 4B, where the fused instruction implementation continues from step 414. It is appreciated that a store instruction or cracked store instruction (without fusing instructions) may also be implemented by microprocessor 100A as described above, and as understood by the skilled artisan.

Store address instructions being stored in LS scheduler 112 and the fused instructions (store data and ALU instruction) in ALU scheduler 110 may be issued and executed once ready. The process of storing and executing the store address (STA) portion is illustrated in the left-most side of the flow diagram beginning with step 415 and continuing to step 422, and the process of storing and executing the store data (STD) portion and ALU instruction (ADD) is illustrated in the right-most side of the flow diagram beginning with step 424 and continuing to step 422.

At step 415, the store address has been stored in the LS scheduler 112, and the fused instruction (fused data store) has been stored in the ALU scheduler 110 in step 424, as explained above. As registers associated with the store address instruction (and load address instruction) become ready in the LS scheduler 112, the instructions are issued at step 416 to LS 114A of executor 114 for execution at step 418. Similarly, as registers associated with the fused data store become ready in the ALU scheduler 110, the instructions are issued at step 426 to ALU 114B of executor 114 for execution at step 428.

FIGS. 5C-5E show an example of issuing instructions from the schedulers for execution in a respective execution resource. In the example embodiment of FIG. 5C, which occurs during a first cycle (cycle X) of the microprocessor 100A, instruction 1 (ADD) is selected for issuance to the execution resource (ALU 114B) since the source registers are ready. The results from execution in destination P4 are then broadcast to all other entries in the schedulers. As shown, since instructions 2 and 3 have source registers (P4) matching the destination register (P4) of instruction 1, the microprocessor 100A wakes up instructions 2 and 3. After execution is completed, the address may be written to a load/store queue (not shown), and a signal may be sent to a completion stage (not shown) at step 422.

As used herein, a completion stage may be coupled to the mapper 106, and in one embodiment may include ROB 106A, and coordinates transfer of speculative results into the architectural state of microprocessor 100A. The completion stage may include other elements for handling completion/retirement of instructions and/or storing history including register values, etc. Completion of an instruction refers to commitment of the instruction's result(s) to the architectural state of a microprocessor. For example, in one embodiment, completion of an add instruction includes writing the result of the add instruction to a destination register. Similarly, completion of a load instruction includes writing a value (e.g., a value retrieved from a cache or memory) to a destination register, as described above.

During the second cycle (cycle X+1), and with reference to the example embodiment in FIG. 5D, instructions 2 and 3 are selected for issuance to the execution resource of executor 114 by the microprocessor 100A. In this case, instruction 2 is the fused instruction (including the store data portion and ALU instruction), which is sent to ALU 114B for execution. Once executed, the results from execution in destination P1 are broadcast to all remaining entries. Instruction 3 is the store address portion of the store instruction, which is sent to the LS 114A for execution. Instruction 3 is not broadcast since it does not have a destination address (it is a store address instruction). As shown, since instruction 4 has a source register (P1) matching the destination register (P1) of instruction 2, the microprocessor 100A wake up instruction 4. After execution is completed, the data from the store data may be written to a load/store queue, and the data from the ALU instruction may be written to the ALU 114B. A signal may then be sent to a completion stage (not shown) at step 422.

In the final cycle (cycle X+2) of the microprocessor 100A, and with reference to FIG. 5E, instruction 4 is selected for issuance to the execution resource of executor 114. Instruction 4 is a load register instruction, which is send to LS 114A for execution, and the result of the execution in destination register (P5) is broadcast. As there are no remaining instructions at this stage, the address may be loaded to the load/store queue, and a signal may be sent to the completion stage at step 422.

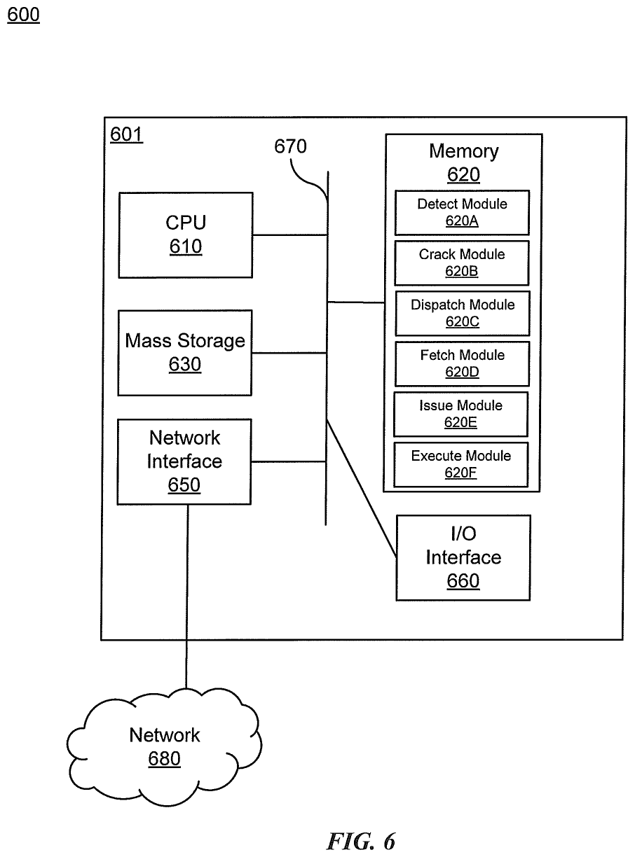

FIG. 6 is a block diagram of a network device 600 that can be used to implement various embodiments. Specific network devices may utilize all of the components shown, or only a subset of the components, and levels of integration may vary from device to device. Furthermore, the network device 600 may contain multiple instances of a component, such as multiple processing units, processors, memories, transmitters, receivers, etc. The network device 600 may comprise a processing unit 601 equipped with one or more input/output devices, such as network interfaces, storage interfaces, and the like. The processing unit 601 may include a central processing unit (CPU) 610, a memory 620, a mass storage device 630, and an I/O interface 660 connected to a bus 670. The bus 670 may be one or more of any type of several bus architectures including a memory bus or memory controller, a peripheral bus or the like.

The CPU 610 may comprise any type of electronic data processor. The memory 620 may comprise any type of system memory such as static random access memory (SRAM), dynamic random access memory (DRAM), synchronous DRAM (SDRAM), read-only memory (ROM), a combination thereof, or the like.

In an embodiment, the memory 620 may include ROM for use at boot-up, and DRAM for program and data storage for use while executing programs. In embodiments, the memory 620 is non-transitory. In one embodiment, the memory 620 includes a detect module 620A detecting a fusion condition exists in response to a source register of a store instruction matching a destination register of an arithmetic operation instruction, a crack module 620B cracking the store instruction into two operation codes, wherein a first operation code includes a store address and a second operation code includes a store data, a dispatch module 620C dispatching the first operation code to a first issue queue and the second operation code, fused with the arithmetic operation instruction, to a second issue queue, a fetch module 620D fetching one or more instructions from memory based on a current address stored in an instruction point register, wherein the one or more instructions comprise at least one of the store instruction and the arithmetic operation instruction, an issue module 620E issuing the first operation code stored in the first issue queue for execution in a load/store stag; and issuing the second operation code fused with the arithmetic operation instruction, stored in the second issue queue, for execution in an arithmetic logic unit (ALU), and an execute module 620F executing the first operation code and the second operation code, fused with the arithmetic operation instruction, upon issuance by a respective one of the first and second issue queues.

The mass storage device 630 may comprise any type of storage device configured to store data, programs, and other information and to make the data, programs, and other information accessible via the bus 670. The mass storage device 630 may comprise, for example, one or more of a solid state drive, hard disk drive, a magnetic disk drive, an optical disk drive, or the like.

The processing unit 801 also includes one or more network interfaces 850, which may comprise wired links, such as an Ethernet cable or the like, and/or wireless links to access nodes or one or more networks 680. The network interface 650 allows the processing unit 601 to communicate with remote units via the networks 680. For example, the network interface 650 may provide wireless communication via one or more transmitters/transmit antennas and one or more receivers/receive antennas. In an embodiment, the processing unit 601 is coupled to a local-area network or a wide-area network for data processing and communications with remote devices, such as other processing units, the Internet, remote storage facilities, or the like.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the following detailed description of the present subject matter, numerous specific details are set forth in order to provide a thorough understanding of the present subject matter. However, it will be clear to those of ordinary skill in the art that the present subject matter may be practiced without such specific details.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

The computer-readable non-transitory media includes all types of computer readable media, including magnetic storage media, optical storage media, and solid state storage media and specifically excludes signals. It should be understood that the software can be installed in and sold with the device. Alternatively the software can be obtained and loaded into the device, including obtaining the software via a disc medium or from any manner of network or distribution system, including, for example, from a server owned by the software creator or from a server not owned but used by the software creator. The software can be stored on a server for distribution over the Internet, for example.

Computer-readable storage media (medium) exclude (excludes) propagated signals per se, can be accessed by a computer and/or processor(s), and include volatile and non-volatile internal and/or external media that is removable and/or non-removable. For the computer, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for executing instructions in a processor, comprising:
detecting, at an instruction fusion stage, a fusion condition exists in response to a source register of a store instruction matching a destination register of an arithmetic operation instruction;
cracking the store instruction into two operation codes, wherein a first operation code includes a store address and a second operation code includes a store data; and
dispatching the first operation code to a first issue queue and the second operation code, fused with the arithmetic operation instruction, to a second issue queue.

2. The computer-implemented method of claim 1, further comprising fetching one or more instructions from memory based on a current address stored in an instruction point register, wherein the one or more instructions comprise at least one of the store instruction and the arithmetic operation instruction.

3. The computer-implemented method of claim 2, further comprising:
decoding the fetched one or more instructions by a decoder into at least one execution operation;
issuing the first operation code stored in the first issue queue for execution in a load/store stage; and
issuing the second operation code fused with the arithmetic operation instruction, stored in the second issue queue, for execution in an arithmetic logic unit (ALU).

4. The computer-implemented method of claim 1, further comprising executing the first operation code and the second operation code, fused with the arithmetic operation instruction, upon issuance by a respective one of the first and second issue queues.

5. The computer-implemented method of claim 4, wherein execution of the first operation code is performed in a load/store stage and execution of the second operation code fused with the arithmetic operation instruction is performed in an arithmetic logic unit (ALU).

6. The computer-implemented method of claim 1, wherein the second operation code fused with the arithmetic operation instruction are stored in a single physical entry of the second issue queue.

7. The computer-implemented method of claim 1, further comprising completing the store instruction when all instructions older than the store instruction have completed and when all instructions in an instruction group that included the store instruction have completed.

8. The computer-implemented method of claim 1, wherein the first and second operation codes are micro-operation instructions.

9. The computer-implemented method of claim 1, wherein the arithmetic operation instruction is one of an ADD, SUBTRACT, MULTIPLY, DIVIDE or a logical operator.

10. A processor for executing instructions, comprising:
fusion logic detecting a fusion condition exists in response to a source register of a store instruction matching a destination register of an arithmetic operation instruction;
cracking logic cracking the store instruction into two operation codes, wherein a first operation code includes a store address and a second operation code includes a store data; and
a dispatcher dispatching the first operation code to a first issue queue and the second operation code, fused with the arithmetic operation instruction, to a second issue queue.

11. The processor of claim 10, further comprising fetching logic fetching one or more instructions from memory based on a current address stored in an instruction point register, wherein the one or more instructions comprise at least one of the store instruction and the arithmetic operation instruction.

12. The processor of claim 11, further comprising:
a decoder decoding the fetched one or more instructions by a decoder into at least one execution operation;
issue logic issuing the first operation code stored in the first issue queue for execution in a load/store stage; and
issue logic issuing the second operation code fused with the arithmetic operation instruction, stored in the second issue queue, for execution in an arithmetic logic unit (ALU).

13. The processor of claim 10, further comprising execution logic executing the first operation code and the second operation code, fused with the arithmetic operation instruction, upon issuance by a respective one of the first and second issue queues.

14. The processor of claim 13, wherein execution of the first operation code is performed in a load/store stage and execution of the second operation code fused with the arithmetic operation instruction is performed in an arithmetic logic unit (ALU).

15. The processor of claim 10, wherein the second operation code fused with the arithmetic operation instruction are stored in a single physical entry of the second issue queue.

16. A non-transitory computer-readable medium storing computer instructions, that when executed by one or more processors, cause the one or more processors to perform the steps of:
detecting a fusion condition exists in response to a source register of a store instruction matching a destination register of an arithmetic operation instruction;
cracking the store instruction into two operation codes, wherein a first operation code includes a store address and a second operation code includes a store data; and
dispatching the first operation code to a first issue queue and the second operation code, fused with the arithmetic operation instruction, to a second issue queue.

17. The non-transitory computer-readable medium of claim 16, further causing the one or more processors to perform the steps of fetching one or more instructions from memory based on a current address stored in an instruction point register, wherein the one or more instructions comprise at least one of the store instruction and the arithmetic operation instruction.

18. The non-transitory computer-readable medium of claim 17, further causing the one or more processors to perform the steps of:
decoding the fetched one or more instructions by a decoder into at least one execution operation;
issuing the first operation code stored in the first issue queue for execution in a load/store stage; and
issuing the second operation code fused with the arithmetic operation instruction, stored in the second issue queue, for execution in an arithmetic logic unit (ALU).

19. The non-transitory computer-readable medium of claim 16, further causing the one or more processors to perform the steps of executing the first operation code and the second operation code, fused with the arithmetic operation instruction, upon issuance by a respective one of the first and second issue queues.

20. The non-transitory computer-readable medium of claim 16, wherein the second operation code fused with the arithmetic operation instruction are stored in a single physical entry of the second issue queue.
